(19) United States
(12) Patent Application Publication
(10) Pub. No.: US 2024/0282516 A1
(43) Pub. Date: Aug. 22, 2024

(54) COIL DEVICE

(71) Applicant: TDK CORPORATION, Tokyo (JP)

(72) Inventors: Hirofumi SASAKI, Tokyo (JP); Keigo HIGASHIDA, Tokyo (JP); Fuyuki MIURA, Tokyo (JP); Ryosuke IINUMA, Tokyo (JP)

(73) Assignee: TDK CORPORATION, Tokyo (JP)

(21) Appl. No.: 18/441,263

(22) Filed: Feb. 14, 2024

(30) Foreign Application Priority Data
Feb. 17, 2023 (JP) 2023-023574

(51) Int. Cl. H01F 41/082; H01F 5/02; H01F 27/28; H01F 41/076

(52) U.S. Cl. CPC H01F 41/082; H01F 5/02; H01F 27/2828; H01F 41/076

(57) ABSTRACT

A coil device includes a winding portion having a wire spirally wound. The winding portion has at least one boundary region. The at least one boundary region divides the winding portion into divided sections along a winding axis of the winding portion.

### BACKGROUND OF THE INVENTION

### 1. Technical Field

The present disclosure relates to a coil device.

### 2. Description of the Related Art

A coil device such as an inductor includes a winding portion around which a wire is spirally wound. Hitherto, various winding methods have been proposed (see, for example, JP H04-246811 A). In a general coil device, a wire is continuously wound in such a way as to reciprocate between a first end and a second end in an axial direction of a winding core. That is, the wire is started to be wound from the first end toward the second end in the axial direction of the winding core, and once the wire is wound to the second end, the wire is wound in the opposite direction from the second end toward the first end. As the wire is wound in this manner, a winding portion having layers in the radial direction is formed.

However, it has been found that it is difficult to secure a frequency characteristic of impedance in a wide high-frequency band due to an inter-wire stray capacitance (a stray capacitance between turns) in the winding methods of the wire according to the related art.

### CITATION LIST

### Patent Literature

Patent Literature 1: JP H04-246811 A

### SUMMARY OF THE INVENTION

The present disclosure has been made in view of such circumstances, and an object of the present disclosure is to provide a coil device capable of broadening a frequency characteristic of impedance in a high frequency band.

In order to achieve the above object, a coil device of the present disclosure includes
a winding portion having a wire spirally wound,
in which the winding portion has at least one boundary region, and
the at least one boundary region divides the winding portion into divided sections along a winding axis of the winding portion.

In the coil device of the present disclosure, the winding portion has at least one boundary region and the at least one boundary region divides the winding portion into the divided sections along the winding axis of the winding portion. Therefore, the winding portion is divided into a first divided section, a second divided section, . . . , and an n-th divided section (n≥2) along the winding axis by at least one boundary region. By dividing the winding portion into the divided sections in this manner, for example, an inter-wire stray capacitance can be reduced between any turn of the first divided section and any turn of the second divided section. As a result, it is possible to broaden a frequency characteristic of impedance in a high frequency band.

The winding axis may be perpendicular to an installation surface of the coil device.

The wire may be continuously wound so as to reciprocate along the winding axis and is stacked in a direction perpendicular to the winding axis in at least one of the divided sections.

The divided sections may include a first divided section and a second divided section adjacent to each other with the boundary region interposed therebetween, and a termination end of the wire in the first divided section and a start end of the wire in the second divided section may be continuous via a connecting portion of the wire.

The wire may be wound from the first divided section toward the second divided section via the connecting portion, and the winding portion may include an odd number of layers in a radial direction of the winding portion in the first divided section.

The wire may be wound from a first end of the first divided section toward a second end of the second divided section opposite to the first end along the winding axis so that the wire is wound toward an installation surface of the coil device.

The wire may further include a leadout portion led out from the winding portion, and the leadout portion may be led out from the outermost layer of the winding portion in a radial direction at a position adjacent to the boundary region in any one of the divided sections.

The wire may further include a leadout portion led out from the winding portion, the leadout portion may be led out from an outermost layer of the winding portion in a radial direction in any one of the divided sections, and the winding portion may include an even number of layers along the radial direction of the winding portion in the any of the divided sections from which the leadout portion is led out.

The coil device may further include a core including a center core portion provided with the winding portion.

### BRIEF DESCRIPTION OF THE DRAWINGS

FIG. 1 is a perspective view of a coil device according to a first embodiment of the present disclosure;

FIG. 2 is a perspective view illustrating an internal configuration of a first core;

FIG. 3 is a perspective view of the first core;

FIG. 4 is a perspective view of a winding portion and terminals;

FIG. 5 is a cross-sectional view taken along line V-V illustrated in FIG. 2;

FIG. 6 is a view illustrating a winding method of the winding portion;

FIG. 7 is a diagram illustrating a frequency characteristic of impedance;

FIG. 8 is a view illustrating a winding method of a winding portion of a coil device according to a second embodiment of the present disclosure;

FIG. 9 is a view illustrating a winding method of a winding portion of a coil device according to a third embodiment of the present disclosure; and

FIG. 10 is a view illustrating a winding method of a winding portion of a coil device according to the related art.

### DETAILED DESCRIPTION

Hereinafter, embodiments of the present disclosure will be described with reference to the drawings. Illustrated contents are merely schematic and exemplary contents for understanding the present disclosure, and appearances, dimensional ratios, and the like may be different from the actual ones. Further, the present disclosure is not limited to the following embodiments.

### First Embodiment

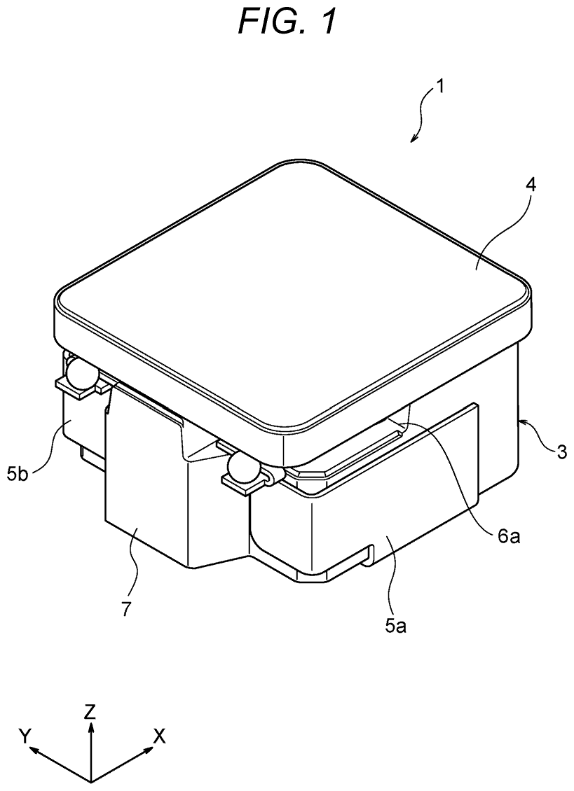

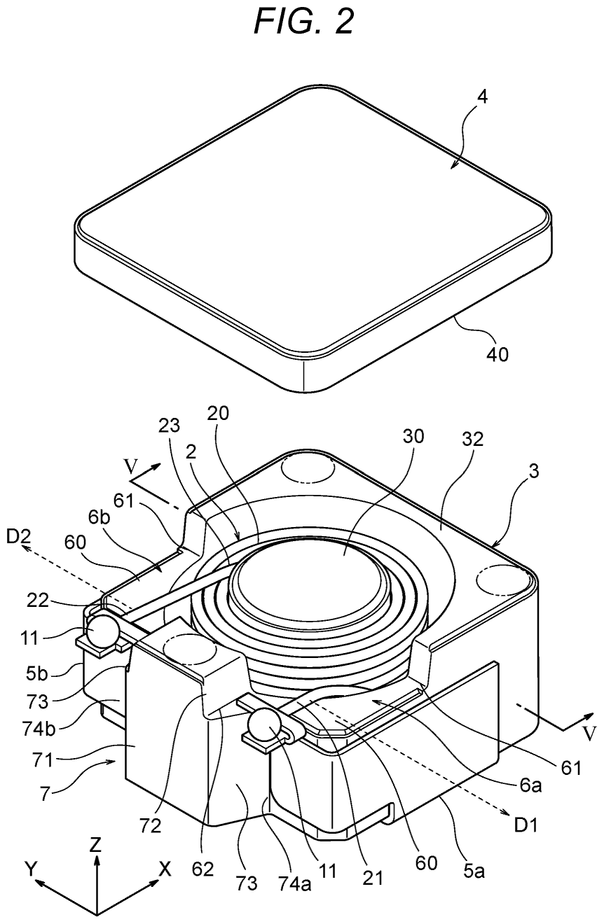

A coil device 1 according to a first embodiment of the present disclosure illustrated in FIG. 1 functions as, for example, an inductor and is mounted on a filter circuit or the like of various electronic devices. As illustrated in FIG. 2, the coil device 1 includes a winding portion 20 formed by spirally winding a wire 2. The coil device 1 may further include a first core 3, a second core 4, and terminals 5a and 5b.

The wire 2 includes a conductive core wire such as a round wire or a flat wire made of copper, for example. The wire 2 may be an insulated coated wire in which the conductive core wire is coated with an insulating film. The wire 2 may be a self-fusion wire in which a fusion layer is formed. A diameter of the wire 2 is, for example, 10 to 400 μm. The winding portion 20 is, for example, an air-core coil, and is provided in the first core 3. A winding axis of the winding portion 20 is perpendicular to an installation surface of the coil device 1 (a surface facing a substrate on which the coil device 1 is installed). The number of layers of the winding portion 20 in a radial direction is plural, and the wire 2 is wound in such a way as to reciprocate along the winding axis in at least a part of the winding portion 20.

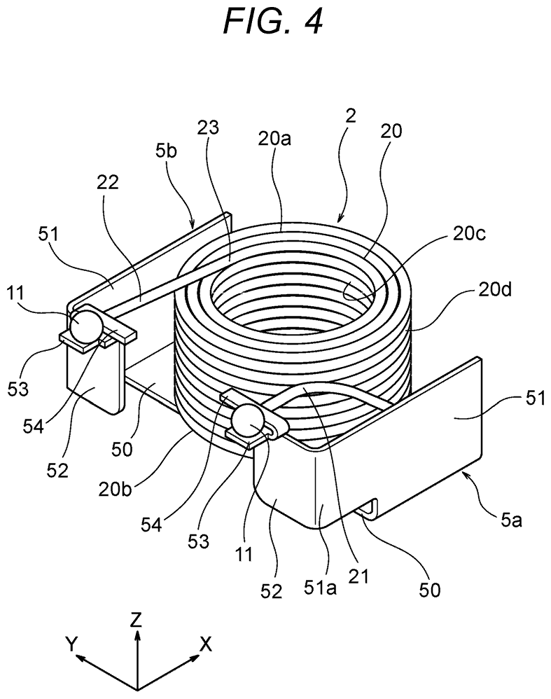

As illustrated in FIG. 4, the wire 2 further includes leadout portions 21 and 22 led out from the winding portion 20 in addition to the winding portion 20. The leadout portion 21 extends from the winding portion 20 to one end of the wire 2, and the leadout portion 22 extends from the winding portion 20 to the other end of the wire 2. The leadout portions 21 and 22 are led out in the same direction. Therefore, the leadout portions 21 and 22 can be led out from the winding portion 20 while suppressing formation of the wire 2. Further, in the winding portion 20, the number of turns of the wire 2 can be increased to adjust inductance. The leadout portions 21 and 22 may be led out in different directions. The leadout portions 21 and 22 are led out in parallel, and may be led out non-parallel.

An extending direction (leadout direction) of the leadout portions 21 and 22 is a direction parallel to an X axis. Alternatively, the extending direction of the leadout portions 21 and 22 is a direction inclined at a predetermined angle along an XY plane with respect to the X axis. Here, the predetermined angle is not particularly limited, and is less than 20 degrees.

Hereinafter, one end of the winding portion 20 in a winding axis direction is referred to as a first end 20a, and the other end of the winding portion 20 in the winding axis direction is referred to as a second end 20b. The leadout portion 21 is led out from the second end 20b of the winding portion 20. However, the leadout portion 21 may be led out from a position between the first end 20a and the second end 20b of the winding portion 20. For example, the leadout portion 21 may be led out from a position closer to the first end 20a or the second end 20b than the center of the winding portion 20 in the winding axis direction. Alternatively, the leadout portion 21 may be led out from the center of the winding portion 20 in the winding axis direction. The leadout portion 22 is led out from the first end 20a of the winding portion 20. However, the leadout portion 22 may be led out from a position between the first end 20a and the second end 20b of the winding portion 20. For example, the leadout portion 22 may be led out from a position closer to the first end 20a or the second end 20b than the center of the winding portion 20 in the winding axis direction. Alternatively, the leadout portion 21 may be led out from the center of the winding portion 20 in the winding axis direction.

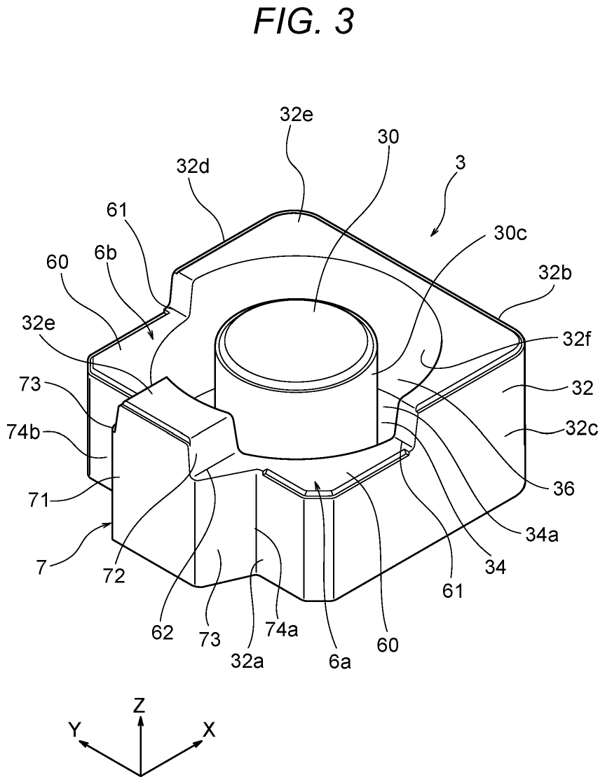

As illustrated in FIG. 3, the first core 3 is a pot core, and is formed of a material containing a magnetic material and a resin. In the present embodiment, the first core 3 mainly contains metal magnetic material particles. Examples of the metal magnetic material particles include Fe—Ni alloy powder, Fe—Si alloy powder, Fe—Si—Cr alloy powder, Fe—Co alloy powder, Fe—Si—Al alloy powder, and amorphous iron. However, the first core 3 may contain ferrite particles or the like instead of the metal magnetic material particles. Examples of the ferrite particles include Ni—Zn-based ferrite and Mn—Zn-based ferrite. Examples of the resin contained in the first core 3 include an epoxy resin, a phenol resin, a polyester resin, a polyurethane resin, a polyimide resin, other synthetic resins, and other nonmagnetic materials. The first core 3 is formed by powder compaction or injection molding of a material containing the above-described magnetic material and a resin. The first core 3 may mainly contain the ferrite particles instead of the metal magnetic material particles. Alternatively, the first core 3 may be a sintered body of the metal magnetic material.

The first core 3 includes, for example, a center core portion 30, a side wall portion 32, and a bottom wall portion 34. The center core portion 30 has a columnar shape and protrudes from a central portion of the bottom wall portion 34. The center core portion 30 may protrude at a position offset from the central part of the bottom wall portion 34 in the radial direction. A shape of the center core portion 30 is not limited to the shape illustrated in FIG. 3, and may be, for example, a quadratic pole, an octagonal pole, or another polygonal pole. As illustrated in FIGS. 2 and 3, the winding portion 20 is provided on an outer peripheral surface 30c of the center core portion 30. The center core portion 30 is disposed on an inner side of the winding portion 20 in the radial direction, and passes inside the winding portion 20 along the winding axis.

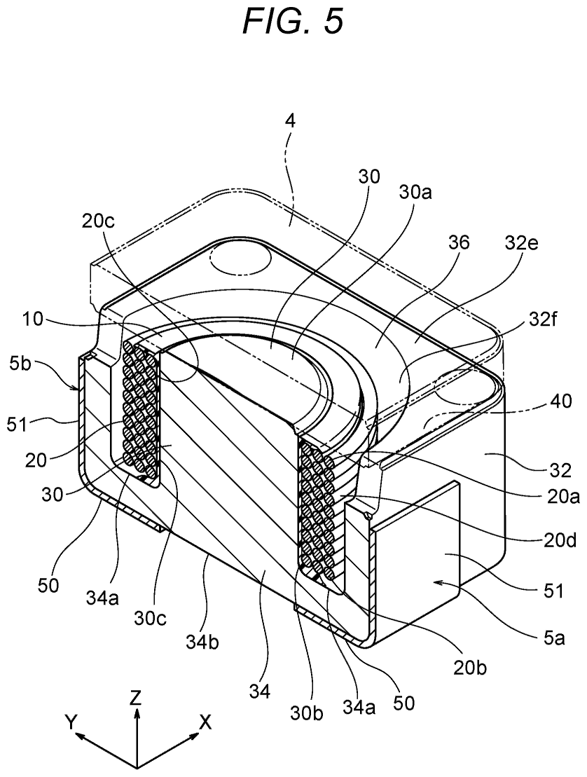

A length of the center core portion 30 in an axial direction may be larger than a length of the winding portion 20 in the winding axis direction. Hereinafter, one end of the center core portion 30 in the axial direction is referred to as a first end 30a, and the other end of the center core portion 30 in the axial direction is referred to as a second end 30b. As illustrated in FIG. 5, the first end 20a of the winding portion 20 is offset from the first end 30a of the center core portion 30 toward the installation surface of the coil device 1 in the axial direction of the center core portion 30. Therefore, a leadout position of the leadout portion 22 (FIG. 2) can be adjusted in the axial direction of the center core portion 30 according to a offset width of the first end 20a. Thus, the leadout portion 22 can be led out from the winding portion 20 while suppressing the formation of the wire 2.

As illustrated in FIGS. 2 and 3, the side wall portion 32 protrudes from an outer edge portion of the bottom wall portion 34 in the same direction as the center core portion 30. The side wall portion 32 is positioned outside the center core portion 30 in the radial direction and surrounds the center core portion 30 from outside in the radial direction. The side wall portion 32 is positioned outside the winding portion 20 in the radial direction and surrounds the winding portion 20 from outside in the radial direction. An outer peripheral surface of the side wall portion 32 is substantially quadrangular as viewed from the winding axis direction of the winding portion 20. However, a shape of the outer peripheral surface of the side wall portion 32 is not limited to a quadrangle, and may be a hexagon, an octagon, another polygon, a circle, an ellipse, or other shapes.

The side wall portion 32 includes a first surface 32a, a second surface 32b facing the first surface 32a, a third surface 32c, and a fourth surface 32d facing the third surface 32c. In FIGS. 2 and 3 and the like, the X axis is an axis parallel to a direction in which the first surface 32a and the second surface 32b face each other. A Y axis is an axis parallel to a direction in which the third surface 32c and the fourth surface 32d face each other. A Z axis is an axis perpendicular to the X axis and the Y axis. The Z axis is an axis parallel to the winding axis direction of the winding portion 20, the axial direction of the center core portion 30, and the axial direction of the side wall portion 32 described above.

A ridge portion positioned between the first surface 32a and the third surface 32c is chamfered. Similarly, a ridge portion positioned between the first surface 32a and the fourth surface 32d is chamfered. A ridge portion positioned between the second surface 32b and the third surface 32c is curved in a cross-section of the side wall portion 32. Similarly, a ridge portion positioned between the second surface 32b and the fourth surface 32d is curved in the cross-section of the side wall portion 32. However, the chamfered portions and the curved portions are not essential and may be omitted.

The side wall portion 32 further includes an end surface 32e and an inner peripheral surface 32f. The end surface 32e is a surface formed one end of the side wall portion 32 in the axial direction. The end surface 32e is formed at an opening edge of a recessed space 36 located between the center core portion 30 and the side wall portion 32, and extends in a direction perpendicular to the axial direction of the side wall portion 32. The end surface 32e is positioned on one side (Z-axis positive direction side) along the Z axis with respect to the first end 20a of the winding portion 20. Therefore, for example, when the side wall portion 32 is viewed along the X axis from a second surface 32b side of the side wall portion 32, the first end 20a is hidden by the side wall portion 32 (the second surface 32b) and is not exposed to the second surface 32b side.

The inner peripheral surface 32f extends along the outer peripheral surface 30c of the center core portion 30. A shape of the inner peripheral surface 32f viewed in a Z-axis direction is a circular shape, and may be, for example, a quadrangular shape, an octagonal shape, or another polygonal shape.

As illustrated in FIG. 5, the bottom wall portion 34 includes a bottom surface 34a and an installation surface 34b. The bottom surface 34a is formed at the bottom of the recessed space 36 and extends along a circumferential direction of the center core portion 30. The second end 20b of the winding portion 20 is disposed on the bottom surface 34a. However, a space may be formed between the bottom surface 34a and the second end 20b, and the space may be filled with a resin 10 such as an adhesive.

The installation surface 34b is positioned on a side opposite to the bottom surface 34a along the Z axis. The installation surface 34b is a surface perpendicular to the axial direction of the center core portion 30 or the side wall portion 32. In addition, the installation surface 34b is a surface facing the substrate (not illustrated) on which the coil device 1 is installed. In the present embodiment, the installation surface 34b may be referred to as the installation surface of the coil device 1.

As illustrated in FIGS. 2 and 3, the recessed space 36 is a space sandwiched between the outer peripheral surface 30c of the center core portion 30 and the inner peripheral surface 32f of the side wall portion 32, and extends along the circumferential direction of the center core portion 30. The winding portion 20 is accommodated in the recessed space 36. The recessed space 36 may be filled with the resin 10 for bonding an inner peripheral surface 20c (FIG. 4) of the winding portion 20 to the outer peripheral surface 30c of the center core portion 30 (see FIG. 5).

As illustrated in FIGS. 2 and 3, cutout portions 6a and 6b cut toward the other end of the side wall portion 32 in the axial direction are formed at one end (the end surface 32e) of the side wall portion 32 in the axial direction. The cutout portions 6a and 6b extend in a circumferential direction of the side wall portion 32. Further, the cutout portions 6a and 6b extend from the inner peripheral surface 32f of the side wall portion 32 to the outer peripheral surface (the first surface 32a, the third surface 32c, and the fourth surface 32d) in the radial direction of the side wall portion 32. A length of a part of the inner peripheral surface 32f of the side wall portion 32 cut by the cutout portion 6a or 6b in the circumferential direction may be two times or more, four times or more, six times or more, eight times or more, or ten times or more the diameter of the wire 2.

The leadout portion 21 passes through the cutout portion 6a, and the leadout portion 22 passes through the cutout portion 6b. The leadout portion 21 is led out from the inside to the outside of the side wall portion 32 in the radial direction through the cutout portion 6a. The leadout portion 22 is led out from the inside to the outside of the side wall portion 32 in the radial direction through the cutout portion 6b.

The cutout portion 6a and the cutout portion 6b are separated from each other in the circumferential direction of the side wall portion 32. The cutout portions 6a and 6b are positioned closer to the first surface 32a than the center of the side wall portion 32 in the X-axis direction as a whole. The cutout portion 6a is positioned closer to the third surface 32c than the center of the side wall portion 32 in a Y-axis direction as a whole. The cutout portion 6b is positioned closer to the fourth surface 32d than the center of the side wall portion 32 in the Y-axis direction as a whole.

For example, ⅛ or more of the end surface 32e of the side wall portion 32 may be cut out to form the cutout portion 6a or 6b. Alternatively, ⅙ or more of the end surface 32e of the side wall portion 32 may be cut out to form the cutout portion 6a or 6b. Alternatively, ⅕ or more of the end surface 32e of the side wall portion 32 may be cut out to form the cutout portion 6a or 6b.

For example, ¼ or more of the end surface 32e of the side wall portion 32 may be cut out to form the cutout portions 6a and 6b. Alternatively, ⅓ or more of the end surface 32e of the side wall portion 32 may be cut out to form the cutout portions 6a and 6b.

The cutout portion 6a and the cutout portion 6b have the same shape, and may also have different shapes. For example, one of the cutout portions 6a and 6b may extend longer in the circumferential direction of the side wall portion 32 than the other.

The cutout portion 6a is continuously formed from the first surface 32a to the third surface 32c in the circumferential direction of the side wall portion 32. The cutout portion 6a is formed across the surfaces of the side wall portion 32, and the ridge portion between the first surface 32a and the third surface 32c is cut to form the cutout portion 6a. A first end 61, which is one end of the cutout portion 6a in an extending direction, is positioned at the center of the third surface 32c in the X-axis direction. Here, the center of the third surface 32c in the X-axis direction includes a position shifted from the center of the third surface 32c in the X-axis direction toward a positive X-axis direction or a negative X-axis direction by about 5 to 10% of the length of the third surface 32c in the X-axis direction. The first end 61 may be positioned closer to the first surface 32a or may be positioned closer to the second surface 32b than the center of the third surface 32c along the X axis.

A second end 62, which is the other end of the cutout portion 6a in the extending direction, is positioned at a position spaced apart from the center of the first surface 32a in the Y-axis direction toward the third surface 32c by a predetermined distance along the Y axis. Here, the predetermined distance is, for example, a distance corresponding to 5 to 30% of a length of the first surface 32a in the Y-axis direction.

The first end 61 of the cutout portion 6a may be positioned at a position (including the vicinity of the position) spaced apart from a leadout position 23 of the leadout portion 21 on the winding portion 20 in the radial direction of the winding portion 20. Here, the vicinity of the position includes a position shifted from the position by about 5 to 10% of the length of the third surface 32c in the X-axis direction along the X axis.

The cutout portion 6b is continuously formed from the first surface 32a to the fourth surface 32d in the circumferential direction of the side wall portion 32. The cutout portion 6b is formed across the surfaces of the side wall portion 32, and the ridge portion between the first surface 32a and the fourth surface 32d is cut to form the cutout portion 6b. A first end 61, which is one end of the cutout portion 6b in an extending direction, is positioned at the center of the fourth surface 32d in the X-axis direction. Here, the center of the fourth surface 32d in the X-axis direction includes a position shifted from the center of the fourth surface 32d in the X-axis direction toward a positive X-axis direction or a negative X-axis direction by about 5 to 10% of the length of the fourth surface 32d in the X-axis direction. The first end 61 may be positioned closer to the first surface 32a or may be positioned closer to the second surface 32b than the center of the fourth surface 32d along the X axis.

A second end 62, which is the other end of the cutout portion 6b in the extending direction, is positioned at a position spaced apart from the center of the first surface 32a in the Y-axis direction toward the fourth surface 32d by a predetermined distance along the Y axis. Here, the predetermined distance is, for example, a distance corresponding to 5 to 30% of a length of the first surface 32a in the Y-axis direction.

The first end 61 of the cutout portion 6b may be positioned at a position (including the vicinity of the position) spaced apart from a leadout position 23 of the leadout portion 22 on the winding portion 20 in the radial direction of the winding portion 20. Here, the vicinity of the position includes a position shifted from the position by about 5 to 10% of the length of the fourth surface 32d in the X-axis direction along the X axis.

As illustrated in FIGS. 2 and 3, at least a part of the leadout portion 21 is exposed in a direction D1 in FIG. 2 through the cutout portion 6a. Here, the direction D1 is a direction perpendicular to the extending direction of the leadout portion 21 and the axial direction (Z-axis direction) of the side wall portion 32. Therefore, at least a part of the leadout portion 21 is not hidden by the side wall portion 32 (third surface 32c) and is exposed to the outside (third surface 32c side) through the cutout portion 6a when viewed from the direction D1. In a case where the extending direction of the leadout portion 21 is the X-axis direction, at least a part of the leadout portion 21 is exposed in the Y-axis direction through the cutout portion 6a. At least a part of the leadout portion 21 is not hidden by the side wall portion 32 (third surface 32c) and is exposed to the outside (third surface 32c side) through the cutout portion 6a when viewed from the Y-axis direction.

In the present embodiment, a part of the leadout portion 21 is exposed to the outside through the cutout portion 6a when viewed from the direction D1 (the Y-axis direction or a direction inclined along the XY plane with respect to the Y axis) in a section (part) of the side wall portion 32 in the circumferential direction between the first end 61 and the second end 62 of the cutout portion 6a (alternatively, a section (part) of the side wall portion 32 along the X axis between the first end 61 of the cutout portion 6a and the first surface 32a). Alternatively, in this section, the entire leadout portion 21 may be exposed to the outside through the cutout portion 6a when viewed from the direction D1. In this case, the entire leadout portion 21 is not hidden by the side wall portion 32 (third surface 32c) when viewed from the direction D1.

At least a part of the leadout portion 21 is exposed through the cutout portion 6a in the extending direction of the leadout portion 21 (the X-axis direction or a direction inclined along the XY plane with respect to the X axis). Therefore, at least a part of the leadout portion 21 is not hidden by the side wall portion 32 (first surface 32a) and is exposed to the outside (first surface 32a side) through the cutout portion 6a when viewed from the extending direction of the leadout portion 21.

At least a part of the cutout portion 6a is disposed in parallel with the leadout portion 21 outside the leadout portion 21 in the direction D1. Further, the cutout portion 6a extends in the circumferential direction of the side wall portion 32 so as to cross the leadout portion 21.

When viewed from the direction D1, at least a part of the leadout portion 21 (a part of the leadout portion 21 in the present embodiment) is positioned closer to the end surface 32e than a bottom portion 60 of the cutout portion 6a in the axial direction of the side wall portion 32. Alternatively, the entire leadout portion 21 may be positioned closer to the end surface 32e than the bottom portion 60 in the axial direction of the side wall portion 32. Further, a part of the leadout portion 21 may be disposed so as to be in contact with the bottom portion 60.

At least a part of the leadout portion 22 is exposed in a direction D2 in FIG. 2 through the cutout portion 6b. Here, the direction D2 is a direction perpendicular to the extending direction of the leadout portion 22 and the axial direction (Z-axis direction) of the side wall portion 32. Therefore, at least a part of the leadout portion 22 is not hidden by the side wall portion 32 (fourth surface 32d) and is exposed to the outside (fourth surface 32d side) through the cutout portion 6b when viewed from the direction D2. In a case where the extending direction of the leadout portion 22 is the X-axis direction, at least a part of the leadout portion 22 is exposed in the Y-axis direction through the cutout portion 6b. At least a part of the leadout portion 22 is not hidden by the side wall portion 32 (fourth surface 32d) and is exposed to the outside (fourth surface 32d side) through the cutout portion 6b when viewed from the Y-axis direction.

In the present embodiment, the entire leadout portion 22 is exposed to the outside through the cutout portion 6b when viewed from the direction D2 (the Y-axis direction or the direction inclined along the XY plane with respect to the Y axis) in a section (part) of the side wall portion 32 in the circumferential direction between the first end 61 and the second end 62 of the cutout portion 6b (alternatively, a section (part) of the side wall portion 32 along the X axis between the first end 61 of the cutout portion 6b and the first surface 32a). Alternatively, in this section, a part of leadout portion 22 may be exposed to the outside through the cutout portion 6b when viewed from the direction D2. In this case, a part of the leadout portion 22 is hidden by the side wall portion 32 (fourth surface 32d) when viewed from the direction D2.

At least a part of the leadout portion 22 is exposed through the cutout portion 6b in the extending direction of the leadout portion 22 (the X-axis direction or the direction inclined along the XY plane with respect to the X axis). Therefore, at least a part of the leadout portion 22 is not hidden by the side wall portion 32 (first surface 32a) and is exposed to the outside (first surface 32a side) through the cutout portion 6b when viewed from the extending direction of the leadout portion 22.

At least a part of the cutout portion 6b is disposed in parallel with the leadout portion 22 outside the leadout portion 22 in the direction D2. Further, the cutout portion 6b extends in the circumferential direction of the side wall portion 32 so as to cross the leadout portion 22.

When viewed from the direction D2, at least a part of the leadout portion 22 (the entire leadout portion 22 in the present embodiment) is positioned closer to the end surface 32e than a bottom portion 60 of the cutout portion 6b in the axial direction of the side wall portion 32. A part of the leadout portion 22 may be positioned closer to the end surface 32e than the bottom portion 60 in the axial direction of the side wall portion 32. Further, a part of the leadout portion 22 may be disposed in so as to be in contact with the bottom portion 60.

At least a part of the winding portion 20 in the winding axis direction (for example, the first end 20a of the winding portion 20 or the vicinity thereof) is exposed in the direction D1 (the Y-axis direction or the direction inclined along the XY plane with respect to the Y axis) through the cutout portion 6a. Therefore, at least a part of the winding portion 20 is not hidden by the side wall portion 32 (third surface 32c) and is exposed to the outside (third surface 32c side) through the cutout portion 6a when viewed from the direction D1.

At least a part of the winding portion 20 in the winding axis direction (for example, the first end 20a of the winding portion 20 or the vicinity thereof) is exposed in the direction D2 (the Y-axis direction or the direction inclined along the XY plane with respect to the Y axis) through the cutout portion 6b. Therefore, at least a part of the winding portion 20 is not hidden by the side wall portion 32 (fourth surface 32d) and is exposed to the outside (fourth surface 32d side) through the cutout portion 6b when viewed from the direction D2.

At least a part of the winding portion 20 in the winding axis direction is exposed in the extending direction of the leadout portions 21 and 22 (the X-axis direction or the direction inclined along the XY plane with respect to the X axis) through the cutout portions 6a and 6b. Therefore, at least a part of the winding portion 20 is not hidden by the side wall portion 32 (first surface 32a), and is exposed to the outside (first surface 32a side) through the cutout portions 6a and 6b when viewed from the extending direction of the leadout portions 21 and 22.

When viewed from the direction D1, at least a part of the winding portion 20 in the winding axis direction is positioned closer to the end surface 32e than the bottom portion 60 of the cutout portion 6a in the axial direction of the side wall portion 32. When viewed from the direction D2, at least a part of the winding portion 20 in the winding axis direction is positioned closer to the end surface 32e than the bottom portion 60 of the cutout portion 6b in the axial direction of the side wall portion 32.

As illustrated in FIGS. 2 and 3, the side wall portion 32 may further include a protrusion 7. The protrusion 7 protrudes outward in the radial direction from the outer peripheral surface (first surface 32a) of the side wall portion 32. At least a part of the protrusion 7 is positioned between the cutout portion 6a and the cutout portion 6b in the circumferential direction of the side wall portion 32. The protrusion 7 includes a first portion 71. The protrusion 7 may further include a second portion 72 continuous with the first portion 71 along the Z axis.

The first portion 71 protrudes outward in the radial direction from the outer peripheral surface of the side wall portion 32. The first portion 71 is formed at the center of the first surface 32a in the Y-axis direction. The center of the first surface 32a in the Y-axis direction corresponds to the center of the first surface 32a in the circumferential direction of the side wall portion 32. The first portion 71 extends from the installation surface 34b (FIG. 5) of the bottom wall portion 34 to the bottom portions 60 of the cutout portions 6a and 6b in the axial direction of the side wall portion 32. Inclined surfaces 73 are formed on opposite sides of the first portion 71 in the Y-axis direction. An interval between one inclined surface 73 and the other inclined surface 73 decreases toward an outer side of the side wall portion 32 in the radial direction. Therefore, the first portion 71 has a tapered shape that tapers outward in the radial direction of the side wall portion 32.

The second portion 72 protrudes from the bottom portions 60 of the cutout portions 6a and 6b toward one side of the side wall portion 32 (the side opposite to the installation surface of the coil device 1) in the axial direction. A length of the second portion 72 in the Y-axis direction is smaller than a length of the first portion 71 (including the inclined surface 73) in the Y-axis direction. A protrusion length of the second portion 72 along the Z axis is larger than the diameter of the wire 2, and may be two times or more, four times or more, six times or more, eight times or more, or ten times or more the diameter of the wire 2. A top surface of the second portion 72 forms a part of the end surface 32e of the side wall portion 32. Therefore, in a case where the second core 4 is disposed on (bonded to) the end surface 32e as described later, stability (adhesive strength) of the second core 4 with respect to the end surface 32e can be secured.

The second portion 72 is positioned between the second end 62 of the cutout portion 6a and the second end 62 of the cutout portion 6b in the circumferential direction of the side wall portion 32. The second portion 72 is positioned between the leadout portion 21 and the leadout portion 22 in the circumferential direction of the side wall portion 32. Therefore, the second portion 72 facilitates insulation between the leadout portion 21 and the leadout portion 22.

The side wall portion 32 may further include recesses 74a and 74b adjacent to the protrusion 7 in the circumferential direction of the side wall portion 32 (that is, the Y-axis direction). Each of the recesses 74a and 74b is defined (formed) by the first surface 32a and the inclined surface 73 intersecting (inclined with respect to) the first surface 32a. The recess 74a is positioned on one side of the protrusion 7 in the Y-axis direction. The recess 74b is positioned on the other side of the protrusion 7 in the Y-axis direction. The recesses 74a and 74b are recessed toward the inner peripheral surface 32f of the side wall portion 32. Further, the recesses 74a and 74b extend from the installation surface 34b (FIG. 5) of the bottom wall portion 34 to the bottom portions 60 of the cutout portions 6a and 6b in the axial direction of the side wall portion 32.

As illustrated in FIGS. 2 and 3, the terminals 5a and 5b are formed of plate-like conductors such as metal, and are attached to the outer peripheral surface of the side wall portion 32. The terminal 5a is attached across the first surface 32a and the third surface 32c of the side wall portion 32 and the installation surface 34b (FIG. 5) of the bottom wall portion 34. The terminal 5b is attached across the first surface 32a and the fourth surface 32d of the side wall portion 32 and the installation surface 34b of the bottom wall portion 34.

As illustrated in FIG. 4, the terminal 5a includes a wire connecting portion 53 connected to the leadout portion 21. The terminal 5a may further include, for example, an installation portion 50, a first side portion 51, a second side portion 52, and a crimping portion 54. The terminal 5b includes a wire connecting portion 53 connected to the leadout portion 22. The terminal 5b may further include, for example, an installation portion 50, a first side portion 51, a second side portion 52, and a crimping portion 54.

As illustrated in FIG. 5 (see FIG. 3, as appropriate), the installation portion 50 of the terminal 5a is disposed on the installation surface 34b of the bottom wall portion 34 on the third surface 32c side. The installation portion 50 of the terminal 5b is disposed on the installation surface 34b of the bottom wall portion 34 on the fourth surface 32d side. The installation portion 50 is connected to the substrate (not illustrated) on which the coil device 1 is installed via a solder, a conductive adhesive, or the like.

As illustrated in FIGS. 2 and 4 (see FIG. 3, as appropriate), the first side portion 51 is continuous with the installation portion 50 and extends in a direction orthogonal to the installation portion 50. The first side portion 51 may include a narrow portion 51a having a smaller width along the Z axis than other portions. The first side portion 51 of the terminal 5a is disposed on the third surface 32c, and the first side portion 51 of the terminal 5b is disposed on the fourth surface 32d so as to face the first side portion 51 of the terminal 5b along the Y axis. A fillet such as a solder may be formed on the first side portion 51.

The second side portion 52 is continuous with the first side portion 51 and extends in a direction orthogonal to the first side portion 51. The first side portion 51 of the terminal 5a is disposed on the first surface 32a on one side of the protrusion 7 in the Y-axis direction. The first side portion 51 of the terminal 5b is disposed on the first surface 32a on the other side of the protrusion 7 in the Y-axis direction.

The wire connecting portion 53 is continuous with the second side portion 52 and extends in a direction orthogonal to the second side portion 52. The leadout portion 21 is connected to the wire connecting portion 53 of the terminal 5a by welding, and the leadout portion 22 is connected to the wire connecting portion 53 of the terminal 5b by welding. A melting portion (welding ball) 11 is formed on the wire connecting portion 53. The leadout portion 21 or 22 may be connected to the wire connecting portion 53 by using, for example, laser welding, a solder, a conductive adhesive, thermocompression bonding, ultrasonic waves bonding, resistance brazing, ultraviolet curable resin bonding, or the like.

The wire connecting portion 53 of the terminal 5a and the wire connecting portion 53 of the terminal 5b are both disposed on the same side (the first surface 32a side of the side wall portion 32) in the extending direction of the leadout portions 21 and 22 (the X-axis direction or the direction inclined along the XY plane with respect to the X axis). Therefore, the leadout portions 21 and 22 can be led out from the winding portion 20 and further connected to the wire connecting portion 53 of the terminal 5a and the wire connecting portion 53 of the terminal 5b, respectively, while suppressing the formation of the wire 2. Positions of the wire connecting portions 53 of the terminals 5a and 5b are not limited to the positions illustrated in FIGS. 2 and 4.

The wire connecting portion 53 of the terminal 5a is disposed within a range of the recess 74a (inside the recess 74a) when viewed from the axial direction of the side wall portion 32. Further the wire connecting portion 53 of the terminal 5b is disposed within a range of the recess 74b (inside the recess 74b) when viewed from the axial direction of the side wall portion 32. Therefore, in the radial direction of the side wall portion 32, the wire connecting portions 53 of the terminals 5a and 5b are less likely to be disposed at positions spaced apart from the outer peripheral surface of the side wall portion 32 in the radial direction. Therefore, the coil device 1 can be downsized. A part of the wire connecting portion 53 may be disposed outside the range of the recess 74a or 74b (outside the recess 74a or 74b).

The crimping portion 54 is continuous with the wire connecting portion 53 and is formed to be bendable with respect to the wire connecting portion 53. The crimping portion 54 of the terminal 5a crimps the leadout portion 21, and the leadout portion 21 is sandwiched between the crimping portion 54 of the terminal 5a and the wire connecting portion 53. The crimping portion 54 of the terminal 5b crimps the leadout portion 22, and the leadout portion 22 is sandwiched between the crimping portion 54 of the terminal 5b and the wire connecting portion 53. The melting portion 11 may be formed on the crimping portion 54 in addition to the wire connecting portion 53.

As illustrated in FIGS. 1 and 2 (see FIG. 3, as appropriate), the second core 4 is a plate-shaped core and is attached to the end surface 32e of the side wall portion 32. The second core 4 is formed of a material containing a magnetic material and a resin. In the present embodiment, the second core 4 is made of a material different from that of the first core 3, and mainly contains the ferrite particles. The second core 4 is a sintered body of ferrite, but is not limited thereto as long as the second core 4 contains the ferrite particles. The second core 4 may mainly contain the metal magnetic material particles instead of the ferrite particles. Alternatively, the second core 4 may be a sintered body of the metal magnetic material. Although the material of the second core 4 is different from the material of the first core 3 in the present embodiment, the material of the second core 4 may be the same as the material of the first core 3. The permeability of the second core 4 is not particularly limited and may be five times or more the permeability of the first core 3. A plate thickness of the second core 4 is not particularly limited and may be 15% or more of a height of the side wall portion 32 in the axial direction. As the permeability and the plate thickness of the second core 4 are set within the above ranges, occurrence of magnetic saturation can be prevented.

The second core 4 includes an attachment surface 40. The attachment surface 40 is attached to the end surface 32e of the side wall portion 32 with an adhesive or the like. The attachment surface 40 is locally bonded to, for example, regions of the end surface 32e indicated by two-dot chain lines in FIG. 2. Alternatively, the attachment surface 40 may be bonded to the entire end surface 32e.

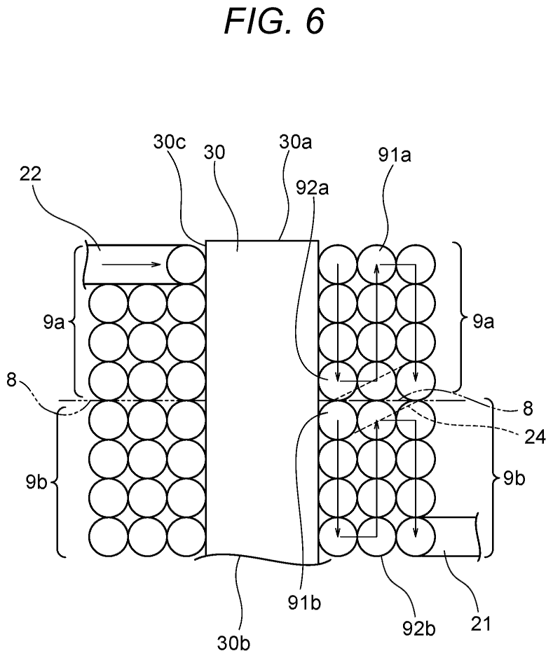

As illustrated in FIG. 6, the winding portion 20 has a boundary region 8. The boundary region 8 divides the winding portion 20 into a divided section 9a and a divided section 9b along the winding axis of the winding portion 20. The divided section 9a and the divided section 9b are adjacent to each other along the winding axis of the winding portion 20 via the boundary region 8. The divided section 9a is stacked on the divided section 9b along the winding axis of the winding portion 20 via the boundary region 8. The divided section 9a and the divided section 9b are in contact with each other via the boundary region 8, and may also be physically separated. Although the winding portion 20 has one boundary region 8 in the present embodiment, the winding portion 20 may have a plurality of boundary regions 8. Further, the winding portion 20 may be divided into three or more divided sections.

The divided section 9a includes a first end 91a and a second end 92a opposite to the first end 91a along the winding axis of the winding portion 20. The divided section 9b includes a first end 91b and a second end 92b opposite to the first end 91b along the winding axis of the winding portion 20. The first end 91a of the divided section 9a and the second end 92b of the divided section 9b are positioned on opposite sides along the winding axis of the winding portion 20. The second end 92b is closer to the installation surface 34b (FIG. 5) of the bottom wall portion 34 than the first end 91b. The second end 92b is positioned near the second end 30b of the center core portion 30, and the first end 91a is positioned near the first end 30a of the center core portion 30.

The wire 2 is wound from the first end 91a toward the second end 92a in the divided section 9a. The wire 2 is wound from the first end 91b toward the second end 92b in the divided section 9b. The wire 2 is wound from the first end 91a of the divided section 9a toward the second end 92b of the divided section 9b as a whole. However, a winding aspect of the wire 2 is not limited thereto, and for example, the wire 2 may be wound from the second end 92b of the divided section 9b toward the first end 91a of the divided section 9a as a whole. The boundary region 8 is positioned between the second end 92a of the divided section 9a and the first end 91b of the divided section 9b, and extends in the radial direction of the winding portion 20.

In the divided section 9a, the wire 2 is continuously wound so as to reciprocate along the winding axis while being stacked in a direction perpendicular to the winding axis of the winding portion 20 (the radial direction of the winding portion 20). More specifically, the wire 2 is wound along the outer peripheral surface 30c of the center core portion 30 toward one side of the winding portion 20 in the winding axis direction (a second end 30b side of the center core portion 30) in the first layer of the winding portion 20 in the radial direction in the divided section 9a as indicated by an arrow in FIG. 6. The wire 2 is wound along an outer peripheral surface of the first layer toward the other side of the winding portion 20 in the winding axis direction (a first end 30a side of the center core portion 30) in the second layer of the winding portion 20 in the radial direction. The wire 2 is wound along an outer peripheral surface of the second layer toward the one side of the winding portion 20 in the winding axis direction in the third layer of the winding portion 20 in the radial direction. As described above, in the divided section 9a, the winding portion 20 includes an odd number of layers (three layers) in the radial direction of the winding portion 20, and a winding direction is reversed in each of the first layer, the second layer, and the third layer of the winding portion 20 in the radial direction.

In the divided section 9b, the wire 2 is continuously wound so as to reciprocate along the winding axis while being stacked in a direction perpendicular to the winding axis of the winding portion 20 (the radial direction of the winding portion 20). More specifically, the wire 2 is wound along the outer peripheral surface 30c of the center core portion 30 toward one side of the winding portion 20 in the winding axis direction (a second end 30b side of the center core portion 30) in the first layer of the winding portion 20 in the radial direction in the divided section 9b as indicated by an arrow in FIG. 6. The wire 2 is wound along an outer peripheral surface of the first layer toward the other side of the winding portion 20 in the winding axis direction (a first end 30a side of the center core portion 30) in the second layer of the winding portion 20 in the radial direction. The wire 2 is wound along an outer peripheral surface of the second layer toward the one side of the winding portion 20 in the winding axis direction in the third layer of the winding portion 20 in the radial direction. As described above, in the divided section 9b, the winding portion 20 includes an odd number of layers (three layers) in the radial direction of the winding portion 20, and the winding direction is reversed in each of the first layer, the second layer, and the third layer of the winding portion 20 in the radial direction.

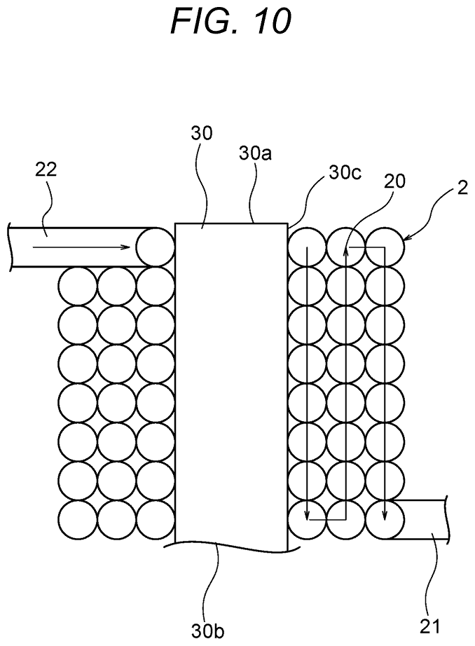

Unlike a winding aspect of a coil device according to the related art as illustrated in FIG. 10, the wire 2 illustrated in FIG. 6 is not continuously wound from the first end 30a to the second end 30b of the center core portion 30 in the first layer of the winding portion 20 in the radial direction. The wire 2 is not continuously wound from the second end 30b to the first end 30a of the center core portion 30 in the second layer of the winding portion 20 in the radial direction. The wire 2 is not continuously wound from the first end 30a to the second end 30b of the center core portion 30 in the third layer of the winding portion 20 in the radial direction. That is, as illustrated in FIG. 6, each of the first layer, the second layer, and the third layer of the winding portion 20 in the radial direction is divided into the divided section 9a and the divided section 9b along the winding axis of the winding portion 20 via the boundary region 8. One virtual winding portion is formed in each of the divided sections 9a and 9b, and two virtual winding portions are disposed in the axial direction of the center core portion 30.

A termination end of the wire 2 in the divided section 9a and a start end of the wire 2 in the divided section 9b are continuous via a connecting portion 24 of the wire 2. The termination end of the wire 2 in the divided section 9a is positioned in the third layer (outermost layer) of the winding portion 20 in the radial direction at the second end 92a of the divided section 9a. The start end of the wire 2 in the divided section 9b is positioned in the first layer of the winding portion 20 in the radial direction at the first end 91b of the divided section 9b. The connecting portion 24 extends from the third layer of the winding portion 20 in the radial direction in the divided section 9a toward the first layer of the winding portion 20 in the radial direction in the divided section 9b so as to straddle the divided section 9a and the divided section 9b.

The wire 2 is wound so as to reciprocate in the divided section 9a, and is further wound from the divided section 9a toward the divided section 9b via the connecting portion 24. As described above, in the divided section 9a, the winding portion 20 includes an odd number of layers (three layers) in the radial direction of the winding portion 20. Therefore, when the wire 2 is wound so as to reciprocate in the divided section 9a, in the outermost layer (third layer) in the radial direction of the winding portion 20 in the divided section 9a, the wire 2 can be smoothly shifted from the divided section 9a to the divided section 9b via the connecting portion 24 without reversing the winding direction of the wire 2 in the middle. The number of layers of the winding portion 20 in the radial direction is not limited to three, and may be five or more as long as it is an odd number. In the present disclosure, it is not essential that the number of layers of the winding portion 20 in the radial direction is an odd number.

The leadout portion 22 is led out from the first layer of the winding portion 20 in the radial direction in the divided section 9a. The leadout portion 21 is led out from the outermost layer (third layer) of the winding portion 20 in the radial direction in the divided section 9b. In the present embodiment, the leadout position of the leadout portion 21 is a position close to the second end 30b of the center core portion 30. The leadout position of the leadout portion 21 is positioned at the second end 92b of the divided section 9b. However, the leadout position of the leadout portion 21 may be positioned at the first end 91b of the divided section 9b in the third layer of the winding portion 20 in the radial direction, or may be positioned between the first end 91b and the second end 92b of the divided section 9b. The leadout portion 21 may be led out from the first layer of the winding portion 20 in the radial direction in the divided section 9b (for example, the second end 92b). Further, the leadout portion 22 may be led out from the outermost layer (third layer) of the winding portion 20 in the radial direction in the divided section 9a (for example, the first end 91a).

Next, a method for manufacturing the coil device 1 will be described. First, the first core 3, the second core 4, and the terminals 5a and 5b illustrated in FIG. 2 are prepared. Next, the terminals 5a and 5b are bonded to predetermined positions on the outer peripheral surface of the first core 3 illustrated in FIG. 2 with an adhesive or the like. Next, as illustrated in FIG. 6, the wire 2 including the winding portion 20 having the boundary region 8 and the divided sections 9a and 9b is prepared. Next, as illustrated in FIG. 2, the winding portion 20 is disposed on the center core portion 30 of the first core 3. Next, as illustrated in FIG. 4, the leadout portion 21 is crimped by the crimping portion 54 of the terminal 5a, and is connected to the wire connecting portion 53 by welding or the like. Further, the leadout portion 22 is crimped by the crimping portion 54 of the terminal 5b, and is connected to the wire connecting portion 53 by welding or the like.

Next, as illustrated in FIG. 5, the recessed space 36 is filled with the resin 10. For example, the resin 10 is poured into the recessed space 36 so that the resin 10 adheres to the first end 20a of the winding portion 20. As a result, a space between the outer peripheral surface 30c of the center core portion 30 and the inner peripheral surface 20c of the winding portion 20 is filled with the resin 10. In addition, a space between the second end 20b of the winding portion 20 and the bottom surface 34a of the bottom wall portion 34 is filled with the resin 10. However, a filling range of the resin 10 is not limited thereto, and for example, a space between an outer peripheral surface 20d of the winding portion 20 and the inner peripheral surface 32f of the side wall portion 32 may be filled with the resin 10.

Next, as illustrated in FIGS. 1 and 2, the second core 4 is bonded to the end surface 32e of the side wall portion 32 with an adhesive or the like. The coil device 1 illustrated in FIG. 1 can be manufactured as described above. A dimension of the coil device 1 is not particularly limited, but a length in the X-axis direction is, for example, 2 to 20 mm, a length in the Y-axis direction is, for example, 2 to 20 mm, and a length in the Z-axis direction is, for example, 1 to 10 mm.

As illustrated in FIG. 6, in the coil device 1 of the present disclosure, the winding portion 20 has at least one boundary region 8 (one boundary region 8 in the present embodiment) that divides the winding portion 20 into divided sections (two divided sections 9a and 9b in the present embodiment) along the winding axis. Therefore, the winding portion 20 is divided into a first divided section, a second divided section, . . . , and an n-th divided section (n≥2) along the winding axis by at least one boundary region 8. It is considered that, for example, an inter-wire stray capacitance can be reduced between any turn of the first divided section (divided section 9a) and any turn of the second divided section (divided section 9b) by dividing the winding portion 20 into the divided sections in this manner. As a result, it is possible to broaden a frequency characteristic of impedance in a high frequency band.

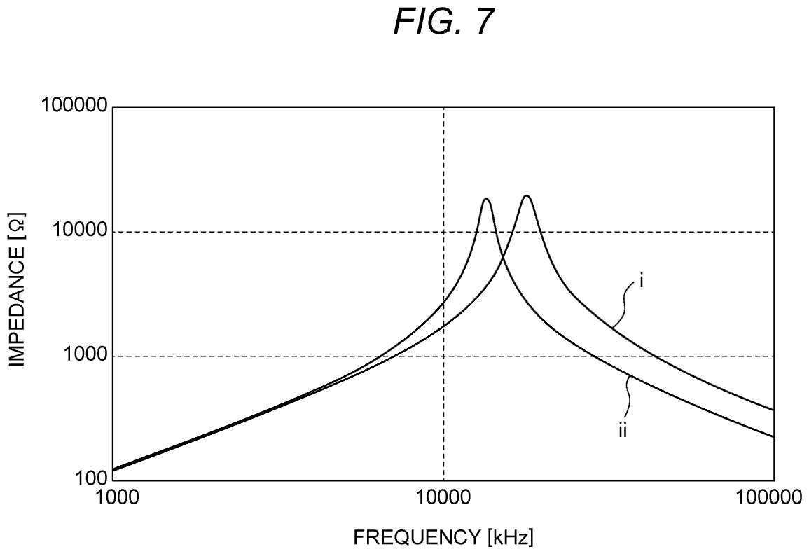

In FIG. 7, a graph i is a graph showing a frequency characteristic of impedance of the coil device 1 of the present embodiment. In addition, a graph ii is a graph showing a frequency characteristic of impedance of the coil device according to the related art. In the coil device 1 of the present embodiment, the winding portion 20 is divided into the divided section 9a and the divided section 9b via the boundary region 8 as illustrated in FIG. 6. On the other hand, in the coil device 1 according to the related art, the wire 2 is wound so as to reciprocate between the first end 30a and the second end 30b of the center core portion 30 in the axial direction of the center core portion 30 as illustrated in FIG. 10. That is, in the coil device according to the related art, the winding portion 20 does not have the boundary region 8.

As is clear from comparison between the graph i and the graph ii in FIG. 7, in the coil device 1 of the present embodiment, the frequency characteristic of the impedance extends to a high frequency band as compared with the coil device according to the related art, and the frequency characteristic of the impedance can be broadened in a high frequency band (for example, 1 MHz or more).

As illustrated in FIG. 5, the winding axis of the winding portion 20 is perpendicular to the installation surface of the coil device 1 (the installation surface 34b of the bottom wall portion 34). Therefore, an installation area of the coil device 1 can be reduced. In a case where the winding portion 20 is disposed on the center core portion 30 of the first core 3 as in the present embodiment, a diameter of the center core portion 30 can be increased. As a result, it is possible to increase a value of a current flowing through the winding portion 20 and further broaden the frequency characteristic of the impedance in a high frequency band.

As illustrated in FIG. 6, the wire 2 is continuously wound so as to reciprocate along the winding axis while being stacked in a direction perpendicular to the winding axis of the winding portion 20 in at least one of the divided sections (the divided sections 9a and 9b in the present embodiment). Therefore, the divided sections 9a and 9b with a plurality of layers are formed in the direction perpendicular to the winding axis of the winding portion 20 (the radial direction of the winding portion 20), so that an inductance value of the coil device 1 can be easily secured. In addition, the boundary region 8 can be formed in the direction perpendicular to the winding axis of the winding portion 20 (the radial direction of the winding portion 20), so that the inter-wire stray capacitance can be reduced between any turn of one of the divided section 9a and any turn of the other divided section 9b adjacent to each other via the boundary region 8.

Further, the divided sections include the divided section 9a and the divided section 9b adjacent to each other with the boundary region 8 interposed therebetween. Further, the termination end of the wire 2 in the divided section 9a and the start end of the wire 2 in the divided section 9b are continuous via the connecting portion 24 of the wire 2. Therefore, it is possible to form the winding portion 20 having the divided section 9a and the divided section 9b while continuously winding the single wire 2.

The wire 2 is wound from the first end 91a of the divided section 9a toward the second end 92b of the divided section 9b positioned on the opposite side to the first end 91a along the winding axis so that the wire 2 is wound toward the installation surface (the installation surface 34b of the bottom wall portion 34) of the coil device 1. Therefore, in a case where the wire 2 is wound so as to reciprocate in the divided section 9a, the wire 2 can be wound in a direction from the first end 91a toward the second end 92b, that is, in a direction from the divided section 9a toward the divided section 9b in the outermost layer (an odd-numbered layer (the third layer in the present embodiment)) of the winding portion 20 in the radial direction in the divided section 9a. Therefore, while the wire 2 is wound from the divided section 9a toward the divided section 9b, the wire 2 can be smoothly shifted from the divided section 9a to the divided section 9b via the connecting portion 24.

In addition, the coil device 1 includes the first core 3 including the center core portion 30 on which the winding portion 20 is provided. Therefore, an inductance characteristic of the coil device 1 can be satisfactorily secured. The value of the current flowing through the winding portion 20 can be adjusted according to a length of the center core portion 30 in the radial direction.

### Second Embodiment

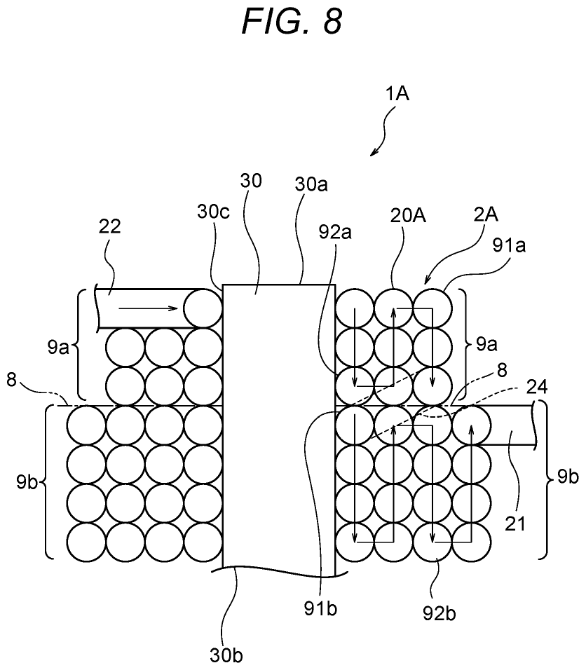

A coil device 1A of a second embodiment illustrated in FIG. 8 has a similar configuration to that of the coil device 1 of the first embodiment except for the following points. Portions overlapping with the coil device 1 of the first embodiment are denoted by the same reference signs, and a detailed description thereof will be omitted. FIG. 8 mainly illustrates a configuration of a winding portion 20A of the coil device 1A.

In the present embodiment, the winding portion 20A includes an even number of layers (four layers) in a radial direction in a divided section 9b. A leadout portion 21 is led out from the outermost layer (fourth layer) of the winding portion 20A in the radial direction in the divided section 9b among the divided sections 9a and 9b. As described above, in a case where the winding portion 20A includes an even number of layers in the radial direction of the winding portion 20A in the divided section 9b, a wire 2A can be wound from a second end 92b toward a first end 91b (from a second end 30b of a center core portion 30 toward a boundary region 8) in the outermost layer of the winding portion 20A in the radial direction in the divided section 9b. As a result, the number of turns of the wire 2A can be secured, and an inductance value of the coil device 1A can be secured. Further, a leadout position of the leadout portion 21 can be adjusted toward the first end 91b along a winding axis of the winding portion 20A.

The leadout portion 21 is led out from the outermost layer of the winding portion 20A in the radial direction at a position (first end 91b) adjacent to the boundary region 8 in the divided section 9b. Therefore, in the divided section 9b, the wire 2A can be wound up to a position adjacent to the boundary region 8 (that is, from the second end 92b to the first end 91b) in the outermost layer (fourth layer) of the winding portion 20A in the radial direction. As a result, the inductance value of the coil device 1A can be secured.

Although the leadout portion 21 is led out from the first end 91b of the divided section 9b, the leadout position of the leadout portion 21 is not limited thereto. The leadout portion 21 may be led out at a turn adjacent to a turn positioned at the first end 91b (that is, a turn adjacent to the second end 92b in an axial direction of the winding portion 20A). The leadout position of the leadout portion 21 may be positioned at the second end 92b of the divided section 9b in the fourth layer of the winding portion 20A in the radial direction, or may be positioned between the first end 91b and the second end 92b of the divided section 9b.

Also in the present embodiment, effects similar to those of the first embodiment can be obtained, and a frequency characteristic similar to the frequency characteristic of the impedance of the coil device 1 of the first embodiment illustrated in the graph i of FIG. 7 can be obtained.

### Third Embodiment

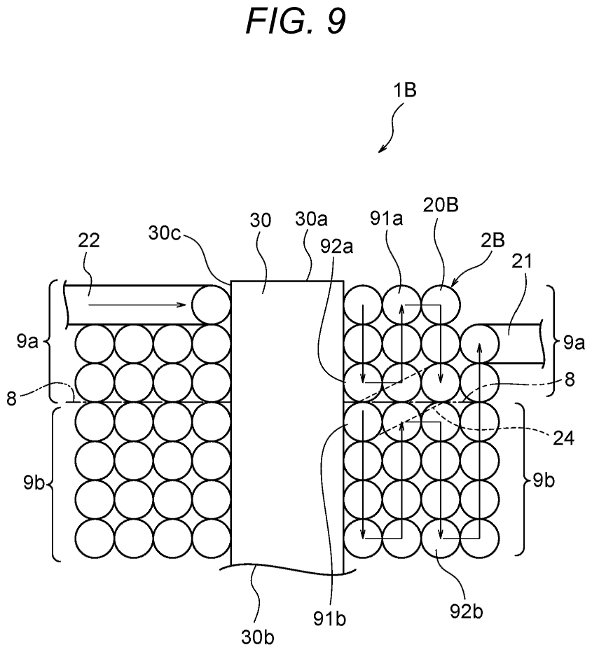

A coil device 1B of a third embodiment illustrated in FIG. 9 has a similar configuration to that of the coil device 1A of the second embodiment except for the following points. Portions overlapping with the coil device 1A of the second embodiment are denoted by the same reference signs, and a detailed description thereof will be omitted. FIG. 9 mainly illustrates the configuration of a winding portion 20B of the coil device 1B.

Also in the present embodiment, a leadout portion 21 is led out from the outermost layer (fourth layer) of the winding portion 20B in a radial direction at a position adjacent to a boundary region 8. However, unlike the second embodiment, in the present embodiment, a wire 2B is wound so as to cross the boundary region 8 from a divided section 9b toward a divided section 9a in an axial direction of a center core portion 30 in the outermost layer of the winding portion 20B in the radial direction. Therefore, the leadout portion 21 is led out from the outermost layer of the winding portion 20B in the radial direction in the divided section 9a.

The leadout portion 21 is led out from a position between a first end 91a and a second end 92a of the divided section 9a, but a leadout position of the leadout portion 21 is not limited thereto. The leadout portion 21 may be led out from the second end 92a of the divided section 9a, or may be led out from the first end 91a of the divided section 9a.

Also in the present embodiment, effects similar to those of the first embodiment can be obtained. In addition, in the present embodiment, the leadout position of the leadout portion 21 can be adjusted toward the first end 91a of the divided section 9a along a winding axis of the winding portion 20B.

The present disclosure is not limited to the above-described embodiments, and various modifications can be made within the scope of the present disclosure.

As illustrated in FIG. 2, the first core 3 is a pot core in the first embodiment. However, the first core 3 may be a core other than the pot core (for example, a dust core formed by powder compaction). In this case, the first core 3 may be formed by installing the winding portion 20 inside a mold, filling the inside of the mold with a material containing a magnetic material and a resin, and compressing the material. The same applies to the second embodiment and the third embodiment.

The winding axis of the winding portion 20 is perpendicular to the installation surface of the coil device 1 in the first embodiment, but the winding axis of the winding portion 20 may also be parallel to the installation surface of the coil device 1. The same applies to the second embodiment and the third embodiment.

As illustrated in FIG. 2, in the first embodiment, at least a part of the leadout portion 21 is exposed to the outside through the cutout portion 6a when viewed from the direction D1. At least a part of the leadout portion 22 is exposed to the outside through the cutout portion 6b when viewed from the direction D2. However, in the present disclosure, these configurations are not essential. The leadout portion 21 may be hidden by the side wall portion 32 (third surface 32c) when viewed from the direction D1. The leadout portion 22 may be hidden by the side wall portion 32 (fourth surface 32d) when viewed from the direction D2.

In the first embodiment, the winding portion 20 has one boundary region 8 as illustrated in FIG. 6, but the winding portion 20 may have two or more boundary regions 8. Further, the winding portion 20 has two divided sections (the divided sections 9a and 9b), but the winding portion 20 may also have three or more divided sections. The same applies to the second embodiment and the third embodiment.

In the first embodiment, the wire 2 is continuously wound so as to reciprocate along the winding axis of the winding portion 20 in each of the divided sections (each of the divided sections 9a and 9b in the present embodiment). However, the wire 2 may be continuously wound in o as to reciprocate along the winding axis of the winding portion 20 in any of the divided sections (for example, only the divided section 9a). The wire 2 may be formed in a single layer in the radial direction of the winding portion 20 in the divided section 9b. The same applies to the second embodiment and the third embodiment.

Reference Signs List

| 1, 1A, 1B | Coil device |
|---|---|
| 2, 2A, 2B | Wire |
| 20, 20A, 20B | Winding portion |
| 20a | First end |
| 20b | Second end |
| 20c | Inner peripheral surface |
| 20d | Outer peripheral surface |
| 21, 22 | Leadout portion |
| 23 | Leadout position |
| 24 | Connecting portion |
| 3 | First core |
| 30 | Center core portion |
| 30a | First end |
| 30b | Second end |
| 30c | Outer peripheral surface |
| 32 | Side wall portion |
| 32a | First surface |
| 32b | Second surface |
| 32c | Third surface |
| 32d | Fourth surface |
| 32e | End surface |
| 32f | Inner peripheral surface |
| 34 | Bottom wall portion |
| 34a | Bottom surface |
| 34b | Installation surface |
| 36 | Recessed space |
| 4 | Second core |
| 40 | Attachment surface |
| 5a, 5b | Terminal |
| 50 | Installation portion |
| 51 | First side portion |
| 51a | Narrow portion |
| 52 | Second side portion |
| 53 | Wire connecting portion |
| 54 | Crimping portion |
| 6a, 6b | Cutout portion |
| 60 | Bottom portion |
| 61 | First end |
| 62 | Second end |
| 7 | Protrusion |
| 71 | First portion |
| 72 | Second portion |
| 73 | Inclined surface |
| 74a, 74b | Recess |
| 8 | Boundary region |
| 9a, 9b | Divided section |
| 91a, 91b | First end |
| 92a, 92b | Second end |
| 10 | Resin |
| 11 | Melting portion |

What is claimed is:

1. A coil device comprising:
a winding portion having a wire spirally wound,
wherein the winding portion has at least one boundary region, and
the at least one boundary region divides the winding portion into divided sections along a winding axis of the winding portion.

2. The coil device according to claim 1, wherein the winding axis is perpendicular to an installation surface of the coil device.

3. The coil device according to claim 1, wherein the wire is continuously wound so as to reciprocate along the winding axis and is stacked in a direction perpendicular to the winding axis in at least one of the divided sections.

4. The coil device according to claim 3,
wherein the divided sections include a first divided section and a second divided section adjacent to each other with the boundary region interposed therebetween, and
a termination end of the wire in the first divided section and a start end of the wire in the second divided section are continuous via a connecting portion of the wire.

5. The coil device according to claim 4,
wherein the wire is wound from the first divided section toward the second divided section via the connecting portion, and
the winding portion includes an odd number of layers in a radial direction of the winding portion in the first divided section.

6. The coil device according to claim 5, wherein the wire is wound from a first end of the first divided section toward a second end of the second divided section opposite to the first end along the winding axis so that the wire is wound toward an installation surface of the coil device.

7. The coil device according to claim 1,
wherein the wire further includes a leadout portion led out from the winding portion, and
the leadout portion is led out from an outermost layer of the winding portion in a radial direction at a position adjacent to the boundary region in any one of the divided sections.

8. The coil device according to claim 1,
wherein the wire further includes a leadout portion led out from the winding portion,
the leadout portion is led out from an outermost layer of the winding portion in a radial direction in any one of the divided sections, and
the winding portion includes an even number of layers in the radial direction of the winding portion in the any of the divided sections from which the leadout portion is led out.

9. The coil device according to claim 1, further comprising a core that includes a center core portion provided with the winding portion.
